(19) United States
(12) Patent Application Publication
(10) Pub. No.: US 2026/0196752 A1
(43) Pub. Date: Jul. 9, 2026

(54) ELECTRICAL CONNECTOR

(71) Applicant: TE Connectivity Japan G. K., Kawasaki-shi (JP)

(72) Inventors: Yoshihiko Kodaira, Kawasaki (JP); Masaaki Iwasaki, Kawasaki (JP); Tetsuya Katano, Kawasaki (JP); Junya Tsuji, Kawasaki (JP)

(73) Assignee: TE Connectivity Japan G. K., Kawasaki-shi (JP)

(21) Appl. No.: 19/444,415

(22) Filed: Jan. 9, 2026

(30) Foreign Application Priority Data
Jan. 9, 2025 (JP) 2025-003412

(51) Int. Cl. H01R 12/70; H01R 13/504; H01R 13/6587; H01R 13/6594; H01R 13/66

(52) U.S. Cl. CPC H01R 12/7064; H01R 13/504; H01R 13/6587; H01R 13/6594; H01R 13/6658

(57) ABSTRACT

An electrical connector includes a plurality of wafers retained within a housing. The electrical connector is connected to a circuit board. Each of the wafers include a wiring board including a plurality of signal wirings and a support that retains the plurality of signal wirings, and a pair of shield plates with the wiring board sandwiched therebetween and each including a plurality of ground terminals press-fitted into the circuit board. A pair of spacers with the pair of shield plates sandwiched therebetween, and each of the plurality of spacers includes a spacer load reception part that receives a sitting load from the housing, and a spacer load transmission part that transmits the sitting load to the shield plate.

### CROSS-REFERENCE TO RELATED APPLICATION

This application claims the benefit of Japanese Patent Application No. 2025-003412 filed on Jan. 9, 2025, the whole disclosure of which is incorporated herein by reference.

### FIELD OF THE INVENTION

The disclosure relates to an electrical connector adapted to be connected to a circuit board

### BACKGROUND OF THE INVENTION

Although each of the large number of press-fitting type terminals included in the electrical connector having this structure is inserted into a through hole (press-fitting hole) of a circuit board, a load (sitting load) to be applied for press-fitting needs to be increased if the number of terminals is large. When the sitting load is large, a buckling load is transmitted to the signal wiring in the wafer so that the signal wiring may be deformed. This may cause a failure in high-speed signal transmission.

Accordingly, an electrical connector including a press-fitting type terminal, an electrical connector capable of preventing a signal wiring from being deformed due to a sitting load is needed.

### SUMMARY OF THE INVENTION

According to an embodiment of the present disclosure, an electrical connector includes a plurality of wafers retained within a housing. The electrical connector is connected to a circuit board. Each of the wafers include a wiring board including a plurality of signal wirings and a support that retains the plurality of signal wirings, and a pair of shield plates with the wiring board sandwiched therebetween and each including a plurality of ground terminals press-fitted into the circuit board. A pair of spacers with the pair of shield plates sandwiched therebetween, and each of the plurality of spacers includes a spacer load reception part that receives a sitting load from the housing, and a spacer load transmission part that transmits the sitting load to the shield plate.

### BRIEF DESCRIPTION OF DRAWINGS

The above and other features of the present invention will become more apparent by describing in detail exemplary embodiments thereof with reference to the accompanying drawings, in which:

FIG. 1 is an isometric view of an electrical connector according to an embodiment as viewed from the front.

FIG. 2 is an isometric view of the electrical connector according to the embodiment as viewed from the rear.

FIG. 3 is a side view of the electrical connector according to the embodiment.

FIG. 4 is a cross sectional view taken along a line Z-Z in FIG. 3.

FIG. 5 illustrates a wafer according to a first aspect included in the electrical connector according to the embodiment, where (a) is a front view, (b) is a side view, and (c) is a rear view.

FIG. 6 is an exploded isometric view of the wafer according to the first aspect, in which the number of shield plates is two, illustrated in FIG. 5.

FIG. 7 is a partially enlarged view of FIG. 4.

FIG. 8 is an exploded isometric view of a wafer according to a second aspect included in the electrical connector according to the embodiment.

FIG. 9 is a cross sectional view of a portion corresponding to a cross section taken along a line Z-Z in FIG. 3 according to the second aspect.

FIG. 10 is a partially enlarged view of FIG. 9.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An electrical connector 1 according to an embodiment will be described below with reference to the accompanying drawings. The electrical connector 1 can be seated against a circuit board by press-fitting a press-fitting type terminal (hereinafter merely referred to as a terminal) into a press-fitting hole of a circuit board without applying a large sitting load to a signal wiring.

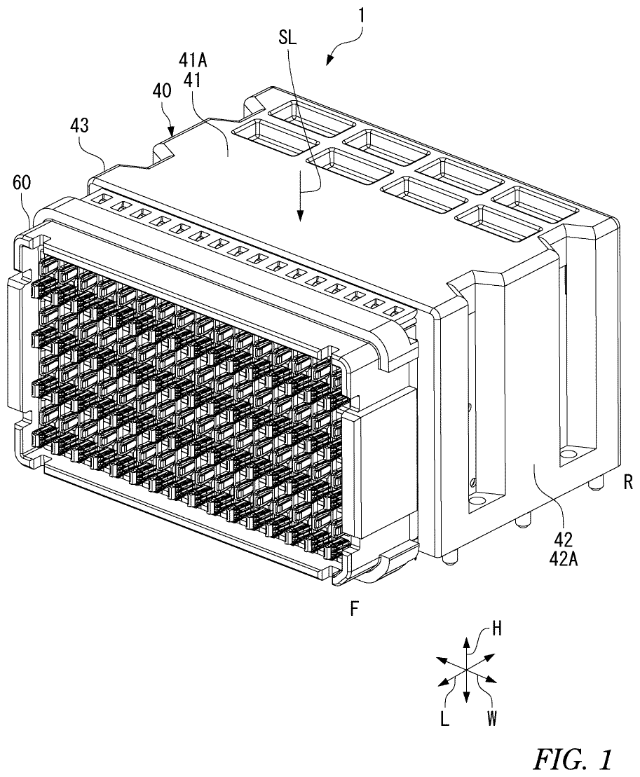

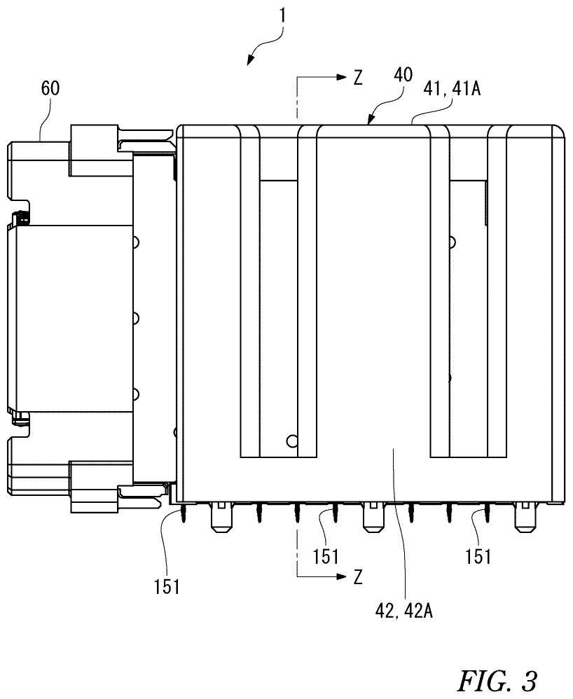

### Entire Configuration of Electrical Connector 1: See FIGS. 1, 2, and 3

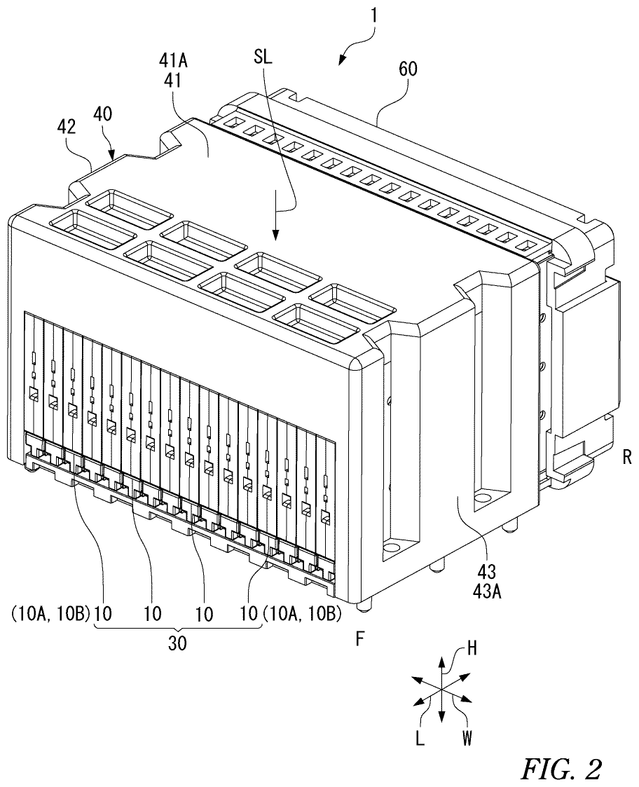

The electrical connector 1 includes a wafer assembly 30 in which a plurality of wafers 10 are combined, a housing 40 that covers the wafer assembly 30 from above and sides, and a shroud 60 provided on the reception side of a mating electrical connector. The electrical connector 1 is connected to a circuit board illustration of which is omitted at the bottom of the drawing, and is connected to the mating electrical connector at the front of the drawing. Note that in the electrical connector 1, a front-rear direction L, a width direction W, and an up-down direction H that are perpendicular to one another are defined and a front F and a rear R are defined, as illustrated in FIGS. 1 and 2, for example.

Although a sitting load SL is applied to a pressing wall 41 provided on the upper side in the drawing of the housing 40, the wafer assembly 30 is provided with a path through which this sitting load is efficiently transmitted to a terminal. The wafer 10 includes a wafer 10A including two shield plates and a wafer 10B including four shield plates. Each of the wafer 10A and the wafer 10B includes a path through which the sitting load is efficiently transmitted to the terminal depending on the number of shield plates. When the wafer 10A and the wafer 10B need not be distinguished, the wafers are merely referred to as the wafer 10.

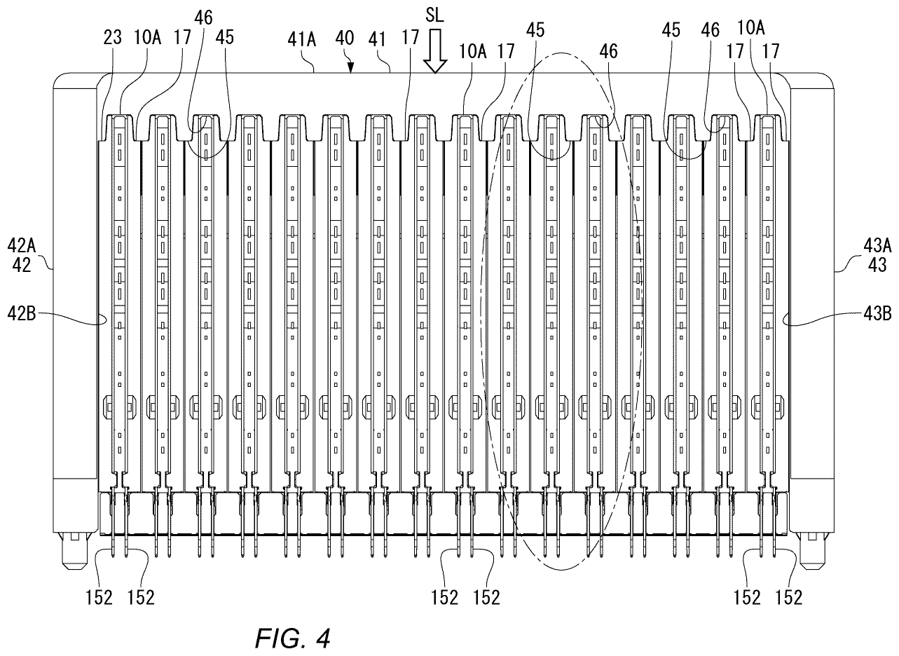

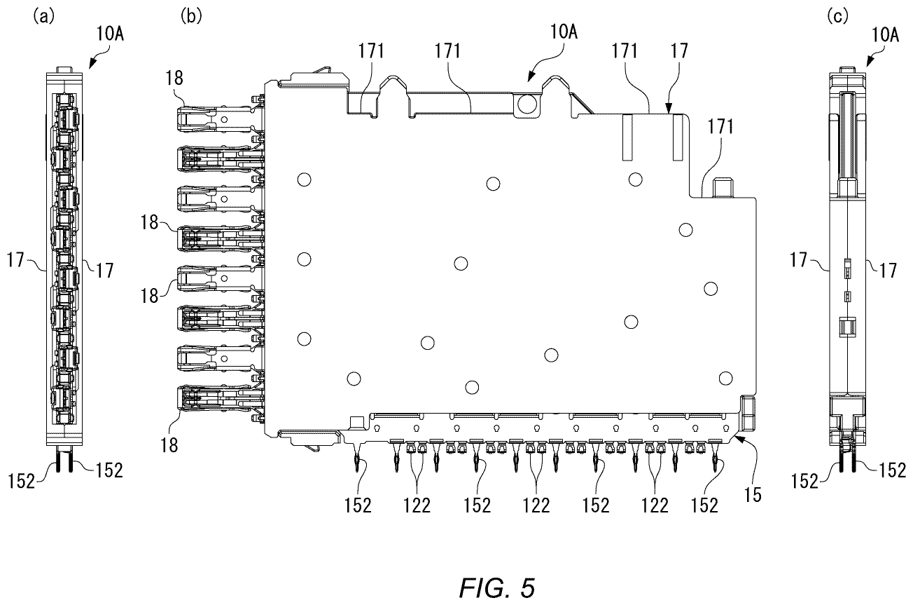

### Wafer 10A (First Aspect): See FIGS. 4, 5, 6, and 7

The wafer 10A includes one wiring board 11, a pair of two shield plates 15 and 15 with the wiring board 11 sandwiched therebetween, a pair of two spaces 17 and 17 with the wiring board 11 and the shield plates 15 and 15 sandwiched therebetween, and a mating insulator 18 that is mated with a distal end of a signal wiring 12 in the wiring board 11.

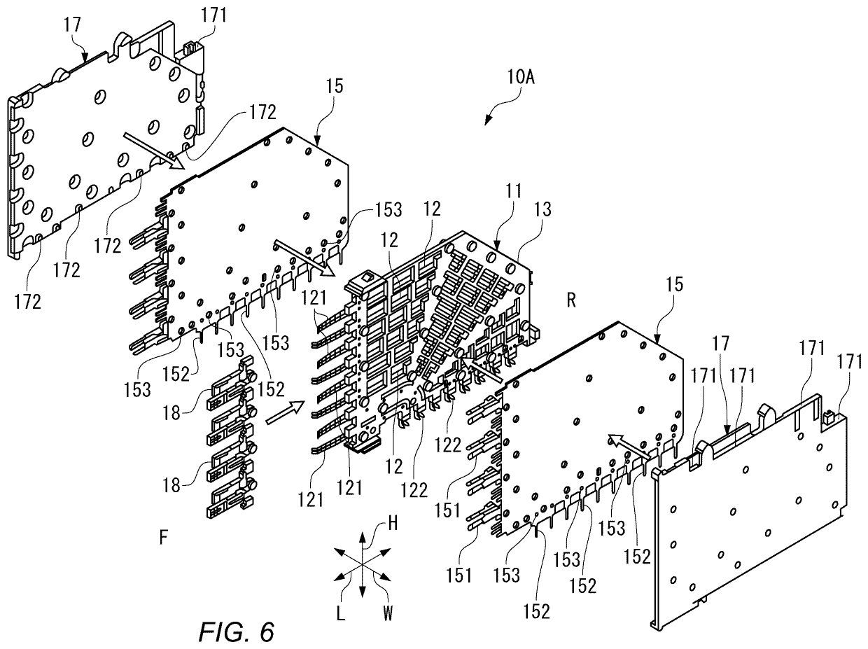

### Wiring Board 11: See FIG. 6

The wiring board 11 includes a plurality of signal wirings 12 arranged and a support 13 that retains the plurality of signal wirings 12. The support 13 is composed of a resin molded body obtained by over molding relative to the signal wirings 12 in a lead frame shape, and the signal wirings 12 and the support 13 are integrated.

Each of the signal wirings 12 has a contact 121, which contacts a mating contact in the mating electrical connector illustration of which is omitted, formed at its one end. In addition, a compression type terminal 122, which is pressed against a pad of the circuit board illustration of which is omitted, is formed in the other end of each of the signal wirings 12. The electrical connector 1 including this wafer 10A is a connector that transfers a signal transmitted/received between the mating electrical connector and the circuit board.

The support 13 has a skeleton structure having gaps respectively formed on both its front and rear surfaces for high-speed signal transmission. The support 13 having the skeleton structure is inferior in mechanical strength, and is thus easily deformed when an external force is applied thereto. When the support 13 is deformed, the signal wirings 12 supported thereby are also deformed. The deformation of the signal wirings 12 causes a malfunction such as a mismatch in an impedance in signal transmission. An external force that may deform the support 13 is the sitting load SL applied to the housing 40 when the wafer assembly 30 is seated on the circuit board. The present embodiment has a structure for avoiding the sitting load SL applied to the housing 40 being applied to the wiring board 11. This structure is formed between the shield plate 15, 15 and the spacer 17, 17 in the wafer 10A.

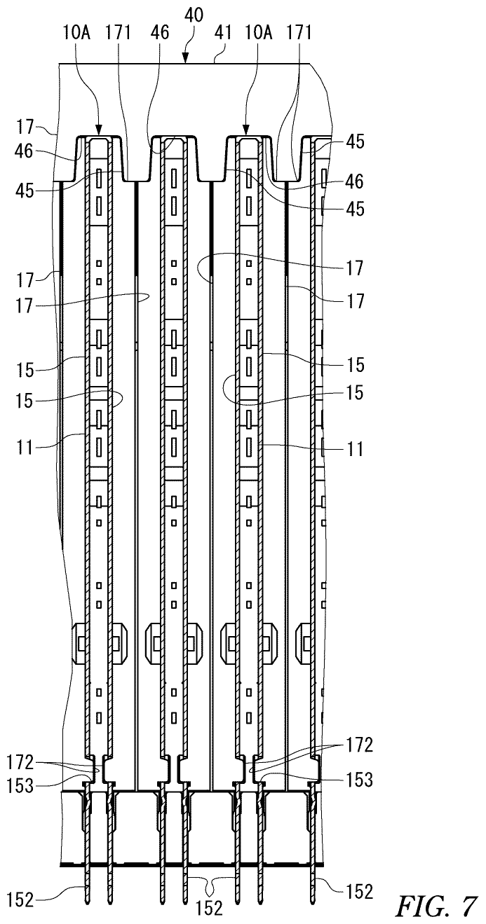

### Shield Plate 15: See FIGS. 6 and 7

The pair of shield plates 15 is positioned to sandwich the wiring board 11 from both sides in the width direction W. A plurality of ground contacts 151, which are connected to a ground contact in the mating electrical connector, are formed and arranged at an end at the front F of each of the shield plates 15. A plurality of ground terminals 152, which are connected to a ground of the circuit board, are formed and arranged at a lower end of each of the two shield plates 15.

Each of the shield plates 15 includes a shield load reception part 153 that receives the sitting load SL transmitted through the spacer 17. The shield load reception part 153 is composed of a through hole that penetrates the front and the rear of the shield plate 15 as an example, so that this shield load reception part 153 is provided at the lower end of the shield plate 15 near the ground terminal 152. In addition, the shield load reception part 153 is provided in each of a plurality of portions between the front F and the rear R of the shield plate 15.

### Spacer 17: See FIGS. 6 and 7

The spacer 17 includes a plurality of spacer load reception parts 171 that receive the sitting load SL via the housing 40. The spacer load reception parts 171 are respectively provided in a plurality of portions in the front-rear direction L of an upper edge of the spacer 17. The upper edge of the spacer 17 corresponds to one end side in the up-down direction H. The spacer load reception parts 171 are thus respectively provided in the plurality of portions in the front-rear direction L, so that the spacer 17 receives the sitting load SL from the housing 40 over its entire area in the front-rear direction L.

In addition, each of the two spacers 17 includes a spacer load transmission part 172 that loads the sitting load SL received by each of the spacer load reception parts 171 onto the ground terminal 152 in the shield plate 15. The spacer load transmission part 172 is provided on the other end side in the up-down direction H. The spacer load transmission part 172 is composed of a projection piece inserted into each of the shield load reception parts 153 in the shield plate 15 sandwiched between the spacers 17. The spacer load transmission part 172 is inserted into the shield load reception part 153 in the shield plate 15 so that a mechanical connection between the spacer 17 and the shield plate 15 is realized. When the sitting load SL is loaded onto the spacer load reception part 171 in the spacer 17, this sitting load SL is transmitted to the ground terminal 152 in the shield plate 15 via the spacer load transmission part 172.

### Housing 40: See FIGS. 4 and 7

The housing 40 covers the wafer assembly 30 from above and both sides to constrain the wafer assembly 30. The housing 40 is produced by integrally molding a metal material using a diecasting method, for example.

The housing 40 includes a pressing wall 41 provided to oppose the circuit board illustration of which is omitted and a first sidewall 42 and a second sidewall 43 that respectively hang from both ends in the width direction W of the pressing wall 41.

The pressing wall 41 includes a front surface 41A exposed to the outside and a rear surface 41B opposing the front surface 41A. The sitting load SL is applied to the front surface 41A composed of a flat surface. This sitting load SL is applied to each of the wafers 10A constituting the wafer assembly 30 from the rear surface 41B. Therefore, the rear surface 41B is provided with a plurality of pressing protrusions 45.

The plurality of pressing protrusions 45 extend in the front-rear direction L, and are arranged parallel to one another with predetermined spacing in the width direction W. In addition, the pressing protrusions 45 are respectively provided in a plurality of portions in the front-rear direction L to correspond to the plurality of spacer load reception parts 171 in the spacer 17. Each of the pressing protrusions 45 abuts against an upper end of the spacer 17 in the adjacent wafer 10, thereby transmitting the sitting load SL to the wafer 10. A retaining groove 46, which houses an upper end of the wafer 10 excluding the spacer 17 on the side of the front surface 41A and performs location in the width direction W, is formed between the pressing protrusions 45 and 45 adjacent to each other in the width direction W. As described above, in the pressing wall 41, the wafer 10 can be pushed downward in the up-down direction H by the pressing protrusions 45, and the wafer 10 can be located in the width direction W by the retaining groove 46. That is, the housing 40 including the pressing protrusions 45 and the retaining groove 46 has a function of locating the wafer 10 compared to a function of transmitting the sitting load SL.

### Effect of Wafer 10A and Housing 40: See FIG. 7

In the electrical connector 1 including the wafers 10A and the housing 40, when the sitting load SL is applied to the housing 40, the sitting load SL is transmitted to the spacer load reception parts 171 and 171 in the adjacent wafers 10A and 10A, respectively, via the pressing protrusions 45. The sitting load SL transmitted to the spacer load reception parts 171 and 171 is transmitted downward in the drawing through the spacers 17 and 17, and is transmitted to the shield load reception parts 153 in the shield plates 15, respectively, from the spacer load transmission parts 172. Thus, the sitting load SL is transmitted to the ground terminals 152 in the shield plates 15, and is inserted into the press-fitting hole of the circuit board illustration of which is omitted. In this way, the electrical connector 1 including the wafers 10A allows the connector to be seated without applying a large load to the support 13, thereby making it possible to ensure a stable signal integrity performance.

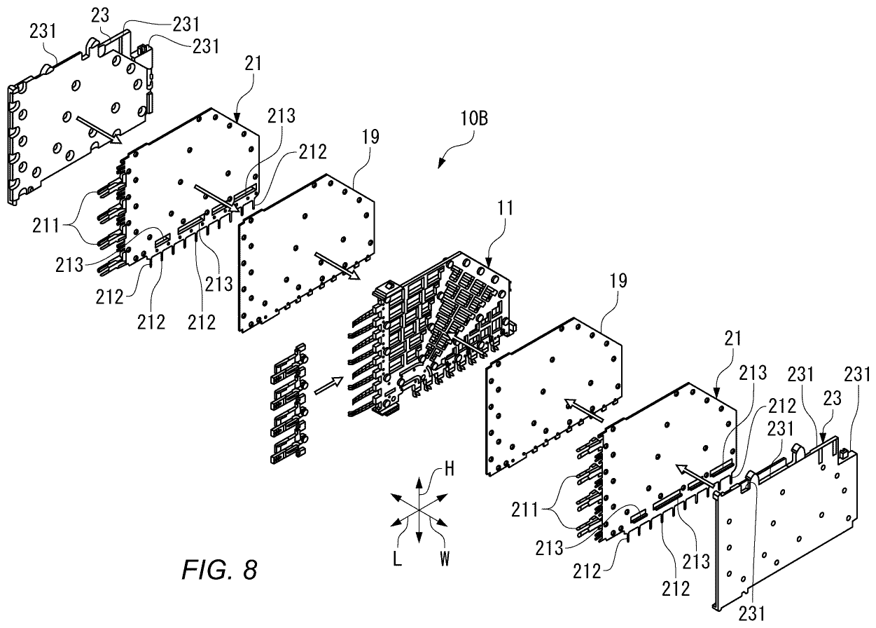

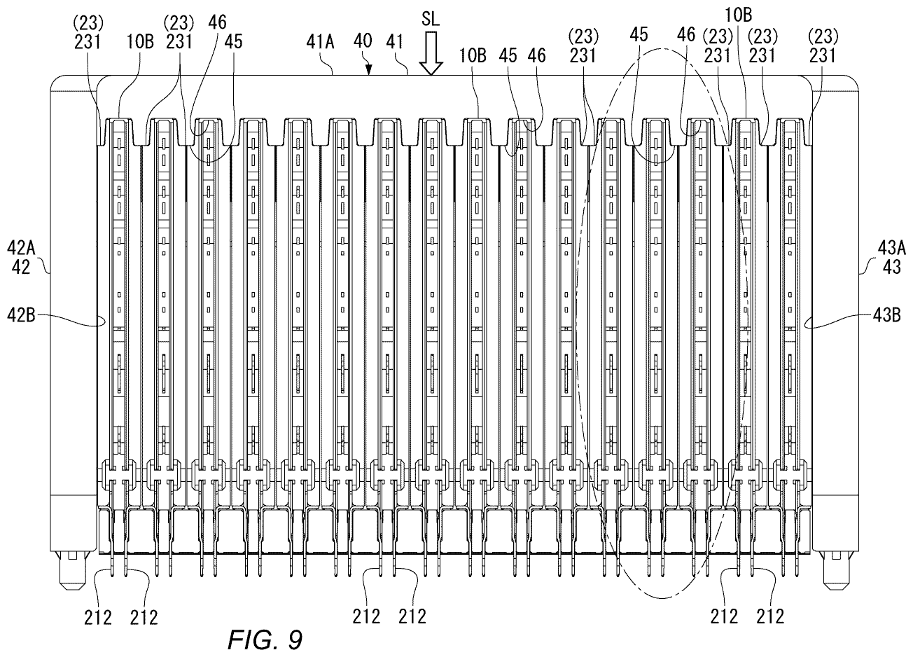

### Wafer 10B: See FIGS. 8 and 9

The wafer 10B includes one wiring board 11, a pair of two inner shield plates 19 and 19 with the wiring board 11 sandwiched therebetween, a pair of two outer shield plates 21 and 21 with the wiring board 11 and the inner shield plates 19 and 19 sandwiched therebetween, a pair of two spacers 23 and 23 with the wiring board 11, the inner shield plates 19 and 19, and the outer shield plates 21 and 21 sandwiched therebetween, and a mating insulator 18 that is mated with a distal end of a signal wiring 12 in the wiring board 11.

In the wafer 10B, a portion of the outer shield plate 21 is provided with a shield load reception part 213 protruding toward the spacer 23, i.e., outward in the width direction W. In addition, the wafer 10B has a structure capable of pushing a spacer load reception part 232 by a spacer load transmission part 232 provided at a lower end of the spacer 23.

The wiring board 11 has basically the same configuration as that of the wiring board 11 in the wafer 10A, and the outer shield plate 21 has basically the same configuration as that of the shield plate 15 in the wafer 10A. In addition, the inner shield plate 19 has a configuration in which the ground contacts 151 and the ground terminals 152 are omitted from the shield plate 15 in the wafer 10A. Therefore, a difference from the wafer 10A will be mainly described below.

### Inner Shield Plate 19: See FIG. 8

The inner shield plate 19 is positioned between the wiring board 11 and the outer shield plate 21. Deformation of the outer shield plate 21 due to the sitting load SL applied to the outer shield plate 21 minimizes a gap occurring between the wiring board 11 and the inner shield plate 19, thereby contributing to high-speed signal transmission in the electrical connector 1.

### Outer Shield Plate 21: See FIGS. 8, 9, and 10

The outer shield plate 21 has a similar function to that of the shield plate 15, and includes a ground contact 211 and a ground terminal 212. In addition, the outer shield plate 21 includes a plurality of shield load reception parts 213 that receive the sitting load SL applied to the housing 40. Each of the shield load reception parts 213 is composed of a cut-and-raised piece that cuts and raises a portion of the outer shield plate 21 to protrude toward the spacer 23 as an example. This shield load reception part 213 is provided at a lower end of the outer shield plate 21 near the ground terminal 212. In addition, the shield load reception parts 213 are respectively provided in a plurality of portions between the front F and the rear R of the outer shield plate 21.

### Spacer 23: See FIGS. 8, 9, and 10

Each of the two spacers 23 includes a plurality of spacer load reception parts 231 that receive the sitting load SL via the housing 40. The spacer load reception parts 231 are respectively provided in a plurality of portions in the front-rear direction L of an upper edge of the spacer 23.

In addition, each of the two spacers 23 includes the spacer load transmission part 232 that transmits the sitting load SL received by each of the spacer load reception parts 231 to the ground terminal 212 in the outer shield plate 21. The lower end of the spacer 23 corresponds to the spacer load transmission part 232 as an example. The spacer load transmission part 232 is caused to abut against each of the shield load reception parts 213 in the outer shield plate 21. When the sitting load SL is loaded onto the spacer load reception part 231 in the spacer 23, this sitting load SL is transmitted to the ground terminal 212 in the shield plate 21 via the spacer load transmission part 232, and is press-fitted into the press-fitting hole of the circuit board illustration of which is omitted.

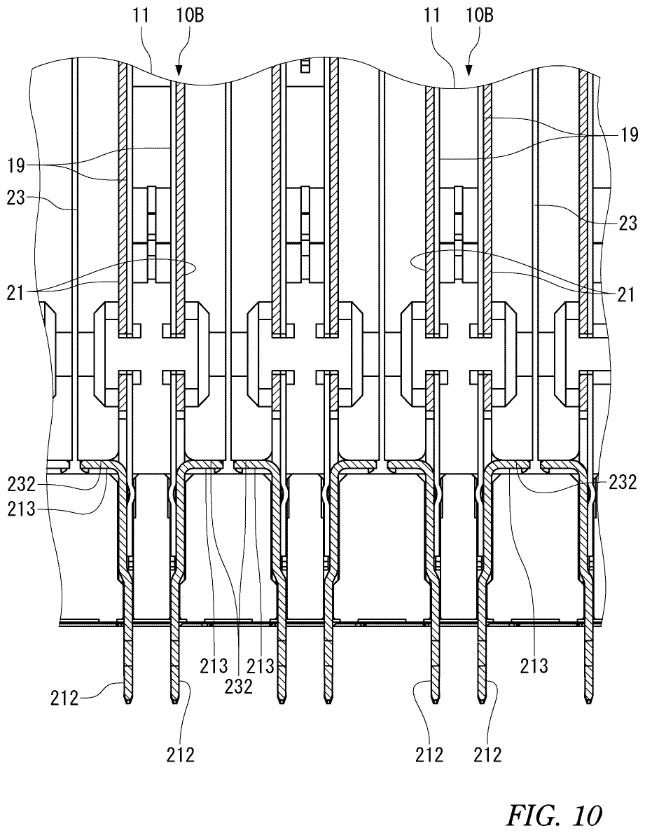

### Effect of Wafer 10B and Housing 40: See FIGS. 9 and 10

In the electrical connector 1 including the wafer 10A and the housing 40, when the sitting load SL is applied to the housing 40, the sitting load SL is transmitted to the spacer load reception parts 231 and 231 in the adjacent wafers 10B and 10B, respectively, via the pressing protrusions 45. The sitting load SL transmitted to the spacer load reception part 231, 231 is transmitted downward in the drawing through the spacer 23, 23, and is transmitted to the shield load reception part 213 in the outer shield plate 21 from the spacer load transmission part 232. Thus, the sitting load SL is transmitted to the ground terminal 212 in the shield plate 21, and is inserted into the pressing hole of the circuit board illustration of which is omitted. Thus, the electrical connector 1 including the wafer 10B also allows the connector to be seated without applying a large load to the support 13, thereby making it possible to ensure a stable signal integrity performance.

In addition to the above, components described in the above embodiment can be sorted out or appropriately changed to other components without departing from the scope of the invention.

In the embodiment, an example of a combination (a first aspect) of the shield load reception part 153 composed of a through hole as an example of a recess and the spacer load transmission part 172 composed of a projection piece and an example of a combination (a second aspect) of the shield load reception part 213 composed of a cut-and-raised piece and the spacer load transmission part 232 have been described. However, the shield load reception part and the spacer load transmission part in the invention are not limited to these examples. A mechanical connection capable of transmitting a sitting load transmitted to a spacer to a shield plate may be formed between the spacer and the shield plate. For example, the shield load reception part can be formed as a projection, and the spacer load transmission part can be formed as a recess, contrary to the first aspect.

The spacer (17, 23) in the embodiment has the spacer load reception part (171, 231) provided on the side of its one end in the up-down direction (H), and has the spacer load transmission part (172, 232) provided on the side of its other end in the up-down direction (H). This is a preferable example in that a load can be transmitted near the ground terminal (152, 212), but the invention is not limited to this. Even if the spacer load transmission part is provided in an intermediate portion in the up-down direction (H), load transmission can be realized.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. An electrical connector comprising:
a plurality of wafers; and
a housing that retains the plurality of wafers,
the electrical connector being connected to a circuit board, wherein
each of the wafers include
a wiring board including a plurality of signal wirings and a support that retains the plurality of signal wirings,
a pair of shield plates with the wiring board sandwiched therebetween and each including a plurality of ground terminals press-fitted into the circuit board, and
a pair of spacers with the pair of shield plates sandwiched therebetween, and
each of the plurality of spacers includes
a spacer load reception part that receives a sitting load from the housing, and
a spacer load transmission part that transmits the sitting load to the shield plate.

2. The electrical connector according to claim 1, wherein
when an up-down direction, a front-rear direction perpendicular to the up-down direction, and a width direction perpendicular to the up-down direction and the front-rear direction are defined,
the spacer has
the spacer load reception part provided on the side of its one end in the up-down direction, and
the spacer load transmission part provided on the side of its other end in the up-down direction.

3. The electrical connector according to claim 2, wherein
the spacer load reception part is provided in each of a plurality of portions in the front-rear direction, and
the spacer load transmission part is provided in each of a plurality of portions in the front-rear direction.

4. The electrical connector according to claim 2 or 3, wherein
the spacer load transmission part includes
a projection piece protruding toward the adjacent shield plate,
the shield plate includes
a shield load reception part composed of a recess into which the projection piece is fitted.

5. The electrical connector according to claim 2 or 3, wherein
the spacer load transmission part is composed of
the one end in the up-down direction of the spacer, and
the shield plate includes
a shield load reception part composed of a cut-and-raised piece that is cut and raised from the shield plate and receives the spacer load transmission part.

6. The electrical connector according to claim 5, wherein
the shield plate includes
a pair of inner shield plates adjacent to the wiring board, and
a pair of outer shield plates with the pair of inner shield plates sandwiched therebetween, and
the shield load reception part is provided in each of the pair of outer shield plates.

7. The electrical connector according to claim 1, wherein
the support is composed of
a resin molded body having a skeleton structure having gaps respectively formed on both its front and rear surfaces.
